(19) United States
(12) Patent Application Publication
(10) Pub. No.: US 2005/0206742 A1
(43) Pub. Date: Sep. 22, 2005

(54) System and apparatus for analyzing video

(75) Inventors: Mitsuyo Hasegawa, Kawasaki (JP); Masaki Miura, Kawasaki (JP); Seiichi Kakinuma, Yokohama (JP); Yasuo Misuda, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/948,759

(22) Filed: Sep. 24, 2004

(30) Foreign Application Priority Data
Mar. 19, 2004 (JP) 2004-080771

(51) Int. Cl. H04N 5/232

(52) U.S. Cl. 348/211.99

(57) ABSTRACT

A video analysis system is disclosed that detects a sensing event by analyzing video captured in each of multiple image sensors connected to a network and notifies a center apparatus of detection information via the network to manage the detection information. The center apparatus determines at least one of the image sensors where the frequency of sensing event occurrence is statistically low by recording the frequency of the notification from each image sensor. The center apparatus reports the determined one of the image sensors to the image sensors as advertisement data. Each image sensor, when being unable to detect the sensing event by real-time processing that is a high-speed video analysis, selects a specific one of the image sensors based on the received advertisement data, and requests the specific one of the image sensors to perform high-accuracy processing that is a low-speed, high-accuracy video analysis.

### BACKGROUND OF THE INVENTION

1. Field of the Invention

The present invention relates generally to video analysis systems and apparatuses, and more particularly to a video analysis system where image analysis is performed in each of multiple image sensors, and to the image sensors employed therein.

2. Description of the Related Art

FIG. 1 is a diagram showing a configuration of a video analysis system employed for monitoring purposes such as traffic monitoring and intruder monitoring. In the system of FIG. 1, each of multiple image sensors 110₁ through 110ₙ performs a variety of sensing operations on data on video captured by a camera, and notifies a center apparatus 116 provided in a monitoring center 14 of processing result information obtained by the sensing operations via a network 12 such as an IP network.

FIG. 2 is a functional block diagram showing the conventional image sensor 110₁. In the image sensor 110₁, video captured by a camera 20 is provided to a detection trigger detection part 21, where a detection trigger is detected. Detecting the detection trigger, the detection trigger detection part 21 provides the video to an image sensing part 22, where sensing is performed on the video. A detection result transmission part 23 transmits detection information that is the result of the sensing to the network 12.

FIG. 3 is a functional block diagram showing the conventional center apparatus 116. In the center apparatus 116, the detection information transmitted from each of the image sensors 110₁ through 110ₙ to the center apparatus 116 via the network 12 is received by a detection result reception part 25, and is provided to a detection result storing part 26. The detection result storing part 26 stores the received detection information in a detection information storage part 27, sorting the received detection information based on its transmitters (the image sensors 110₁ through 110ₙ).

Conventional remote monitoring systems are disclosed in, for instance, Japanese Laid-Open Patent Applications No. 11-75176 and No. 2002-135508. The former discloses a system in which an object of monitoring is constantly monitored by a monitoring terminal unit and image data is transferred to a monitoring center apparatus and displayed thereon when an abnormality is detected. According to this system, a higher resolution is employed in abnormal times than in normal times.

The latter discloses an image processor that exchanges print data via a network. The image processor assigns a job that it cannot process to another apparatus, thereby avoiding processing congestion and increasing image processing operation efficiency.

The image sensors 110₁ through 110₁ are often installed outdoors. In this case, the image sensors 110₁ through 110ₙ are designed not as general-purpose personal computers but as dedicated apparatuses since environmental durability and size and weight reduction are required. Accordingly, it takes some time to perform sensing in the case of real-time sensing. Therefore, an algorithm of high-speed but low-accuracy sensing is employed on the assumption that multiple sensing events occur.

As a result, even when processing capability is not fully utilized with a low frequency of occurrence of sensing events, the high-speed algorithm for the case of the occurrence of multiple sensing events is used. This causes a problem in that an input image that is detectable by a more time-consuming but highly accurate algorithm may not be detected or may be unidentifiable.

High-performance personal computers have been developed in these years. However, an increase in the hardware performance of the image sensors 110₁ through 110ₙ installed in multiple locations leads to an increase in costs, and also causes a problem in the above-described environmental durability. Therefore, the image sensors 110₁ through 110ₙ are poorer in processing performance than those personal computers that enjoy the fastest processing speed available at the time. There is a problem in that the total capability of the image sensors 110₁ through 110ₙ is not utilized with the image sensors 110₁ through 110ₙ simply notifying the center apparatus 116 of their own detection results although the image sensors 110₁ through 110ₙ are connected to the network 12 that allows the image sensors 110₁ through 110ₙ to communicate with one another.

On the other hand, the center apparatus 116 is often installed in the monitoring center 14 offering a good installation environment. A high-performance computer can be installed as the center apparatus 116, but the center apparatus 116 only performs simple processing such as reception, storage, and management of notification results from the image sensors 110₁ through 110ₙ, which is another problem.

### SUMMARY OF THE INVENTION

Accordingly, it is a general object of the present invention to provide a video analysis system and apparatus in which the above-described disadvantages are eliminated.

A more specific object of the present invention is to provide a video analysis system that can detect sensing events through highly accurate video analysis, utilizing the capabilities of all image sensors and/or a center apparatus.

Another more specific object of the present invention is to provide an apparatus employed in the above-described system.

One or more of the above objects of the present invention are achieved by a video analysis system detecting a sensing event by analyzing video captured in each of a plurality of image sensors connected to a network, and notifying a center apparatus of detection information via the network to manage the detection information, wherein: the center apparatus determines at least one of the image sensors in which one a frequency of occurrence of the sensing event is statistically low by recording a frequency of the notification from each of the image sensors, and reports the determined at least one of the image sensors to the image sensors as advertisement data; and each of the image sensors, when being unable to detect the sensing event by real-time processing that is a high-speed video analysis, selects a specific one of the image sensors based on the received advertisement data, and requests the specific one of the image sensors to perform high-accuracy processing that is a low-speed, high-accuracy video analysis.

One or more of the above objects of the present invention are also achieved by an image sensor in a video analysis system detecting a sensing event by analyzing video captured in each of a plurality of image sensors connected to a network, and notifying a center apparatus of detection information via the network to manage the detection information, the image sensor including: an advertisement data retention part configured to receive and retain advertisement data of at least one of the image sensors in which one a frequency of occurrence of the sensing event is low, the advertisement data being reported from the center apparatus; a real-time processing part configured to perform high-speed video analysis; a high-accuracy processing part configured to perform low-speed, high-accuracy video analysis; and a request part configured to select a specific one of the image sensors based on the received advertisement data and request the specific one of the image sensors to perform high-accuracy processing that is the low-speed, high-accuracy video analysis when the sensing event is undetectable by the real-time processing part.

One or more of the above objects of the present invention are also achieved by a center apparatus in a video analysis system detecting a sensing event by analyzing video captured in each of a plurality of image sensors connected to a network, and notifying the center apparatus of detection information via the network to manage the detection information, the center apparatus including a reporting part configured to determine at least one of the image sensors in which one a frequency of occurrence of the sensing event is statistically low by recording a frequency of the notification from each of the image sensors, and report the determined at least one of the image sensors to the image sensors as advertisement data.

According to the present invention, a sensing event can be detected by high-accuracy video analysis utilizing the capacities of all image sensors and a center apparatus.

### BRIEF DESCRIPTION OF THE DRAWINGS

Other objects, features and advantages of the present invention will become more apparent from the following detailed description when read in conjunction with the accompanying drawings, in which:

FIG. 1 is a schematic diagram showing a configuration of a video analysis system employed for monitoring purposes such as traffic monitoring and intruder monitoring;

FIG. 2 is a functional block diagram showing a conventional image sensor;

FIG. 3 is a functional block diagram showing a conventional center apparatus;

FIG. 4 is a schematic diagram showing a configuration of a video analysis system according to the present invention;

FIG. 5 is a functional block diagram showing a first embodiment of an image sensor according to the present invention;

FIG. 6 is a functional block diagram showing a first embodiment of a center apparatus according to the present invention;

FIG. 7 is a diagram showing an operation sequence according to an embodiment of the video analysis system of the present invention;

FIG. 8 is a detailed functional block diagram showing a second embodiment of the image sensor according to the present invention;

FIG. 9 is a functional block diagram showing a second embodiment of the center apparatus of the present invention;

FIG. 10 is a diagram showing a detection information storage format according to the present invention;

FIG. 11 is a diagram showing an advertisement data format according to the present invention;

FIGS. 12A and 12B are flowcharts of processing performed by the image sensor of the present invention; and

FIGS. 13A and 13B are flowcharts of processing performed by the center apparatus of the present invention.

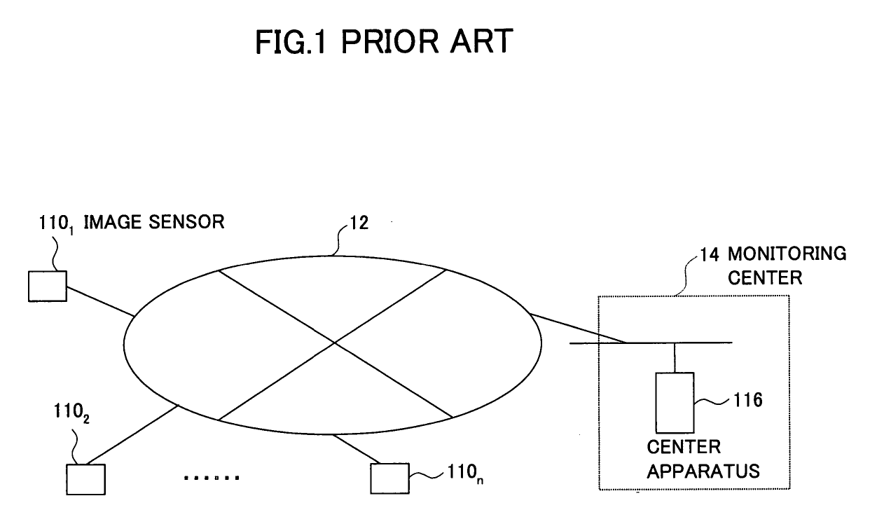

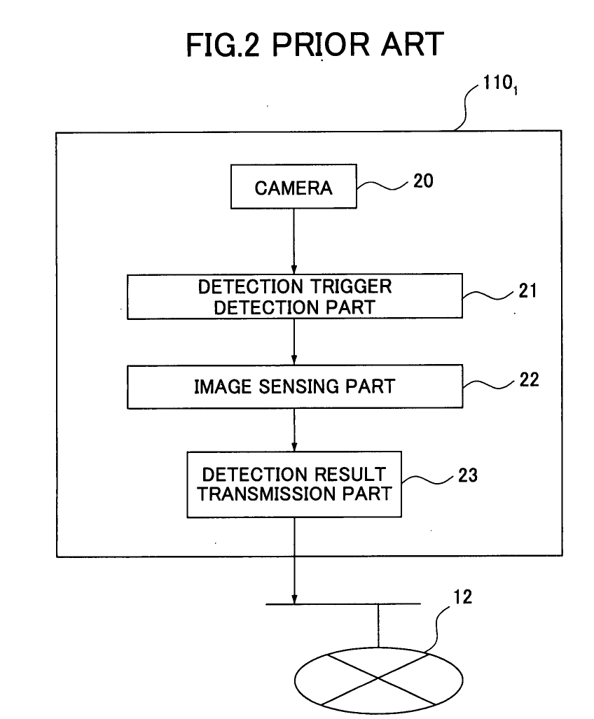

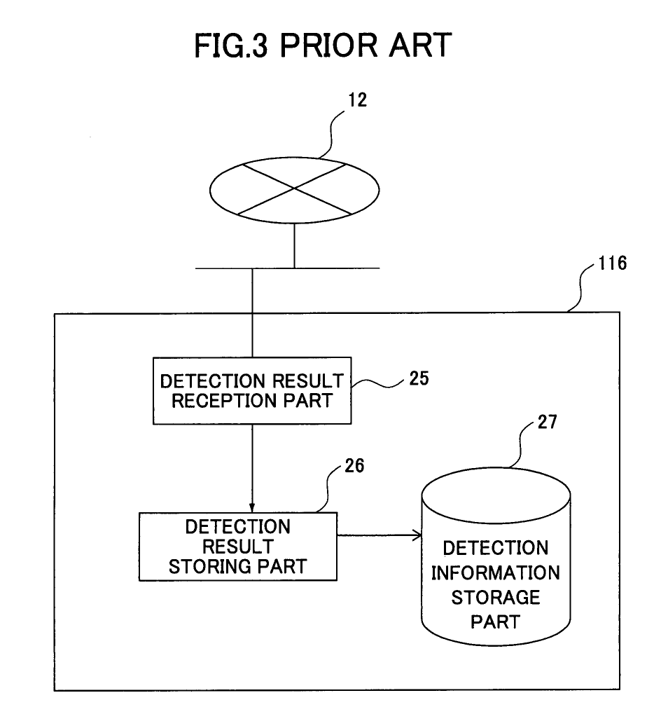

### DETAILED DESCRIPTION OF THE PREFERRED EMBODIMENTS

A description is given next, with reference to the accompanying drawings, of embodiments of the present invention.

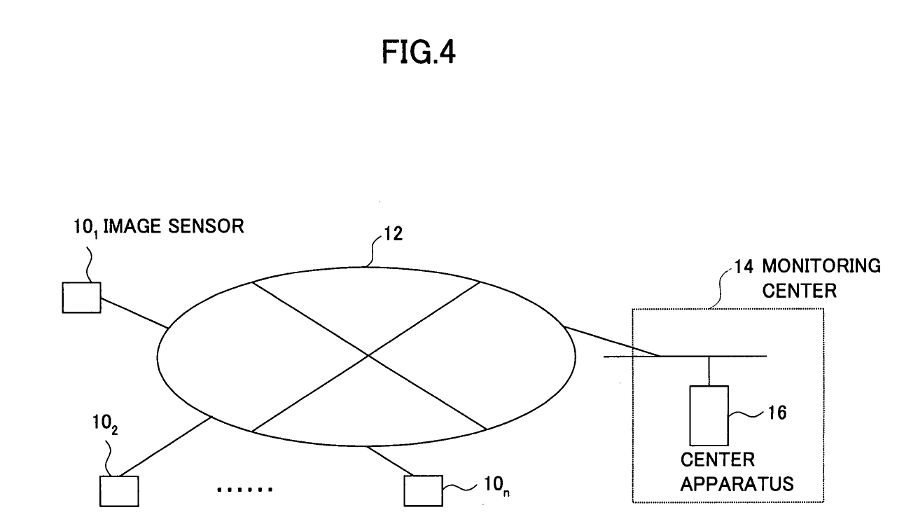

FIG. 4 is a diagram showing a configuration of a video analysis system employed for monitoring purposes such as traffic monitoring and intruder monitoring according to the present invention. In the system of FIG. 4, each of multiple image sensors 10₁ through 10ₙ performs a variety of sensing operations on data on video captured by a camera, and notifies a center apparatus 16 provided in the monitoring center 14 of processing result information obtained by the sensing operations via a network 12 such as an IP network.

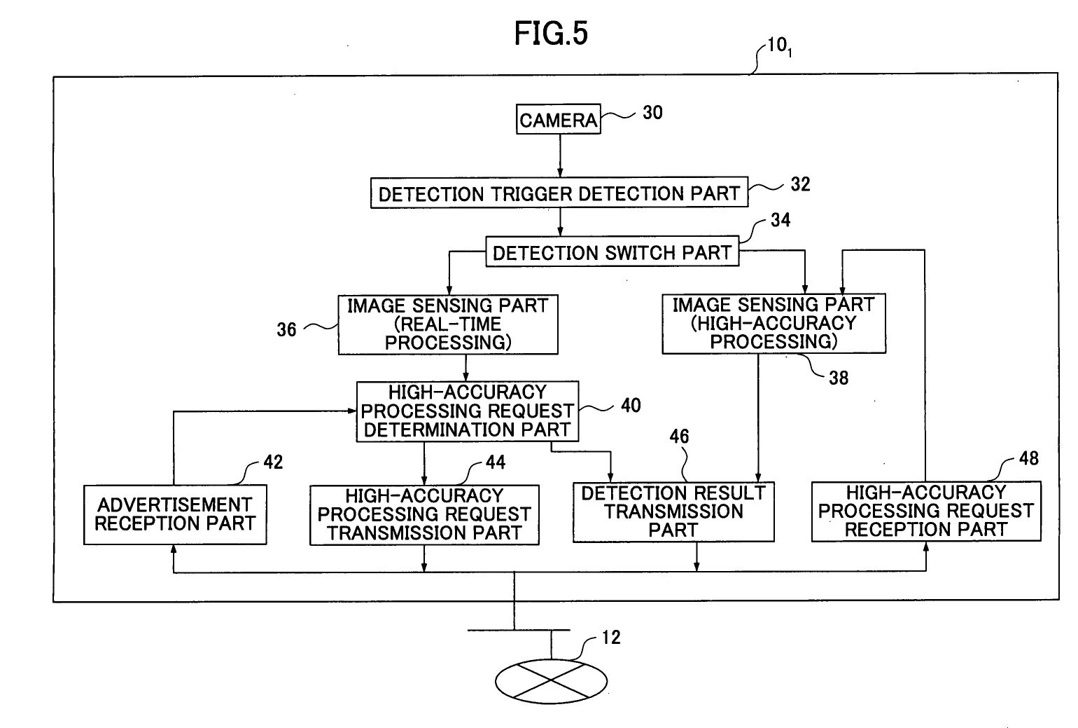

FIG. 5 is a functional block diagram showing a first embodiment of the image sensor 10₁ according to the present invention. The image sensors 10₁ through 10ₙ have the same configuration. In the image sensor 10₁ of FIG. 5, video captured by a camera 30 is provided to a detection trigger detection part 32, where a detection trigger is detected. The detection trigger detection part 32 provides the detected detection trigger to a detection switch part 34.

The detection switch part 34 provides the video to a real-time first image sensing part 36 performing high-speed video analysis (high-speed processing) when the frequency of occurrence of detection triggers, that is, sensing events, is higher than or equal to a predetermined value and to a high-accuracy second image sensing part 38 performing low-speed, high-accuracy video analysis (high-accuracy processing) when the frequency of occurrence of sensing events is lower than a predetermined value.

When the first image sensing part 36 performs real-time processing on the video and no sensing result is determined, a high-accuracy processing request determination part 40 selects a substitute image sensor to request to perform processing (on behalf of the image sensor 10₁) from advertisement information stored in an advertisement reception part 42. Then, the high-accuracy processing request determination part 40 causes a high-accuracy processing request transmission part 44 to transmit to the selected image sensor the video together with a request to perform substitutional low-speed, high-accuracy processing. The advertisement reception part 42 stores the advertisement information reported from the center apparatus 16, the advertisement information being the address of an image sensor where the frequency of occurrence of sensing events is currently low.

Detection information as a sensing result obtained in the first image sensing part 36 is provided from the high-accuracy processing request determination part 40 to a detection result transmission part 46, and is transmitted therefrom to the center apparatus 16 via the network 12. Detection information obtained in the second image sensing part 38 is transmitted from the detection result transmission part 46 to the center apparatus 16 via the network 12.

A high-accuracy processing request reception part 48 receives video together with a request to perform substitutional high-accuracy processing transmitted to the image sensor 10₁ from the network 12, and provides the video to the second image sensing part 38, causing the second image sensing part 38 to perform high-accuracy processing on the video.

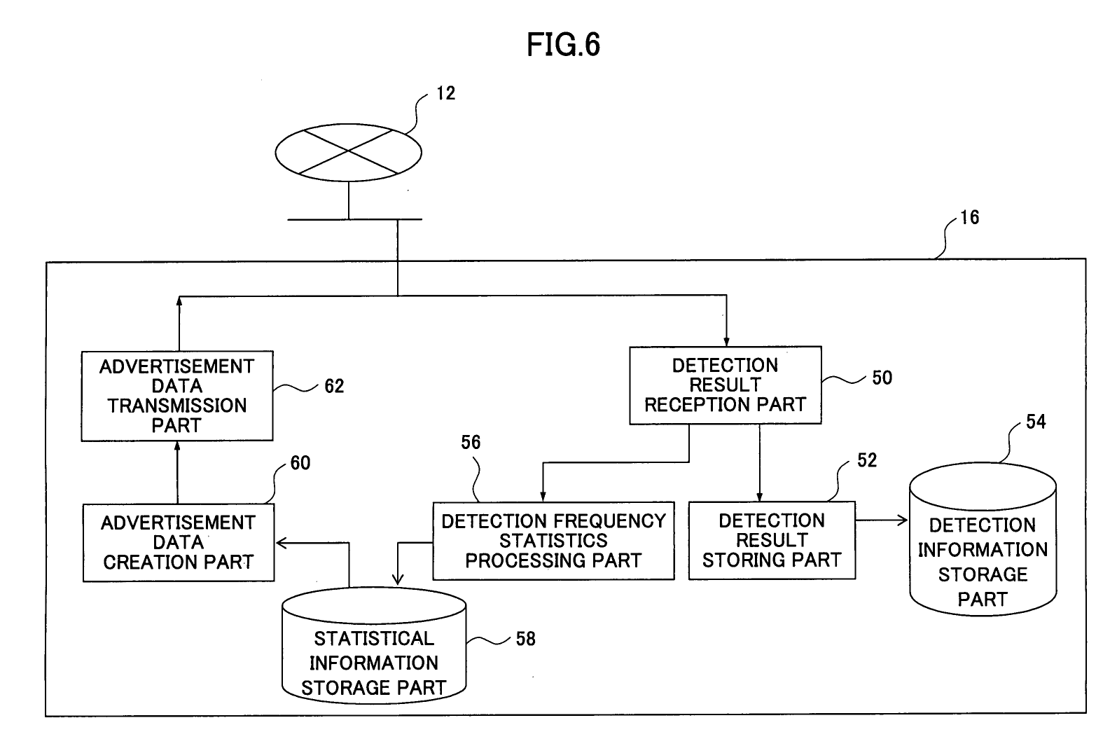

FIG. 6 is a functional block diagram showing a first embodiment of the center apparatus 16 according to the present invention. In the center apparatus 16 of FIG. 6, detection information transmitted from the image sensors 10₁ through 10ₙ to the center apparatus 16 via the network 12 is received by a detection result reception part 50, and is provided to a detection result storing part 52. The detection result storing part 52 stores the received detection information in a detection information storage part 54, sorting the received detection information based on its transmitters (the image sensors 10₁ through 10ₙ).

The detection information received by the detection result reception part 50 is provided to a detection frequency statistics processing part 56. The detection frequency statistics processing part 56 takes statistics on the frequency of notification of sensing events with respect to each of the image sensors 10₁ through 10ₙ, and stores the obtained statistical information in a statistical information storage part 58.

With respect to each of the image sensors 10₁ through 10ₙ, an advertisement data creation part 60 specifies a period of time (a day of the week and time) when the frequency of occurrence of sensing events is lower than a predetermined threshold from the statistical information of the statistical information storage part 58. Then, the advertisement data creation part 60 periodically selects one or more of the image sensors 10₁ through 10ₙ in which the frequency of occurrence of sensing events is currently lower than the predetermined threshold and therefore, the work load on the CPU is small, and creates advertisement data that reports the addresses of the selected one or more of the image sensors 10₁ through 10ₙ. The advertisement data is periodically transmitted from an advertisement data transmission part 62 to the network 12 and reported to all of the image sensors 10₁ through 10ₙ.

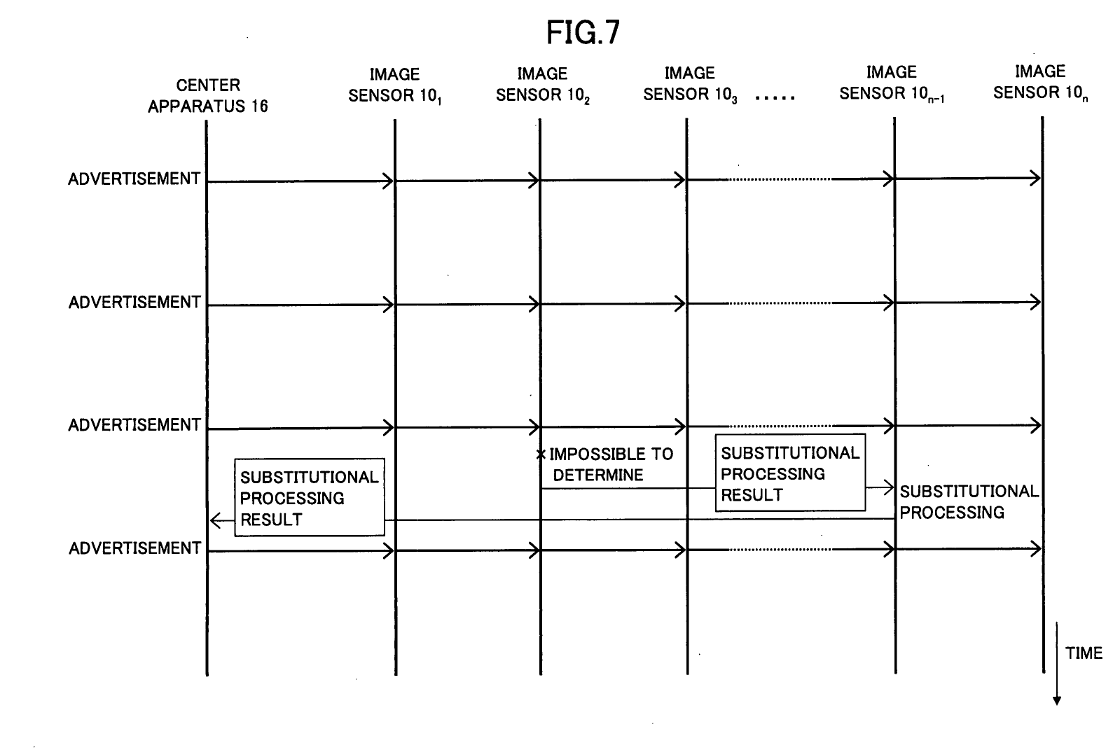

FIG. 7 is a diagram showing an operation sequence according to an embodiment of the video analysis system of the present invention. In this operation sequence, the center apparatus 16 periodically reports advertisement data to all of the image sensors 10₁ through 10ₙ via the network 12.

When the first image sensing part 36 of the image sensor 10₂ performs real-time processing on the video and no sensing result is determined, the image sensor 10₂ transmits the video together with a request to substitutionally perform low-speed, high-accuracy processing to the image sensor 10ₙ₋₁ based on the advertisement data. The image sensor 10ₙ₋₁ performs low-speed, high-accuracy processing on the video, and notifies the center apparatus 16 of the resultant detection information via the network 12.

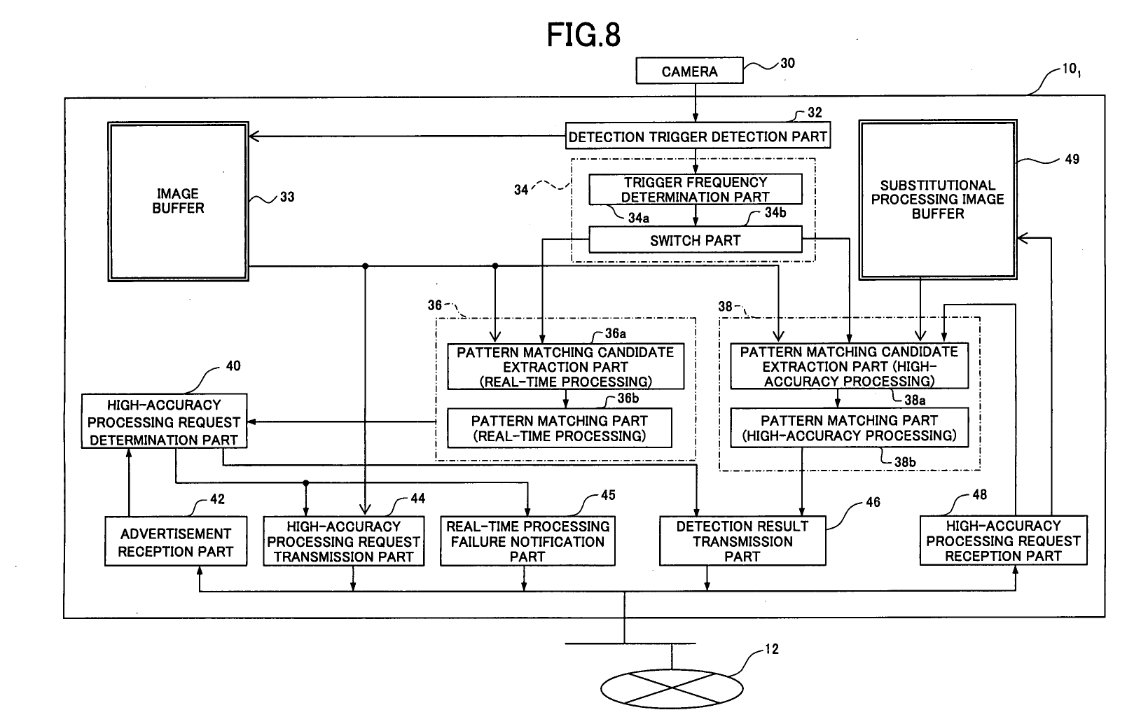

FIG. 8 is a detailed functional block diagram showing a second embodiment of the image sensor 10₁ according to the present invention. In FIG. 8, the same elements as those of FIG. 5 are referred to by the same numerals. In the case of FIG. 8, the image sensors 10₁ through 10ₙ have the same configuration. Referring to FIG. 8, video captured by the camera 30 having a fixed range of image capturing is provided to the detection trigger detection part 32. The detection trigger detection part 32 detects a change in the captured image as a detection trigger, and provides the detection trigger to the detection switch part 34. Further, the detection trigger detection part 32 stores the video in an image buffer 33.

The detection switch part 34 includes a trigger frequency determination part 34a and a switch part 34b. The trigger frequency determination part 34a compares the frequency of occurrence of detection triggers, that is, sensing events, with a predetermined value. If the frequency of occurrence is higher than or equal to the predetermined value, the trigger frequency determination part 34a provides through the switch part 34b an instruction to have the video processed in the first image sensing part 36 performing high-speed, real-time processing. If the frequency of occurrence is lower than the predetermined value, the trigger frequency determination part 34a provides through the switch part 34b an instruction to have the video processed in the second image sensing part 38 performing low-speed, high-accuracy processing.

The first image sensing part 36 includes a pattern matching candidate extraction part 36a and a pattern matching part 36b. The second image sensing part 38 includes a pattern matching candidate extraction part 38a and a pattern matching part 38b. Each of the pattern matching candidate extraction parts 36a and 38a extracts each part of the video read out from the image buffer 33 which part includes a movement as a pattern matching candidate. The pattern matching candidate extraction part 36a outputs, for instance, one or two patterns as candidates, while the pattern matching candidate extraction part 38a outputs, for instance, ten patterns as candidates.

The pattern matching parts 36b and 38b perform pattern matching between each of the candidates provided from the pattern matching candidate extraction parts 36a and 38a, respectively, and multiple templates. That is, the pattern matching parts 36b and 38b collate each of the candidates provided from the pattern matching candidate extraction parts 36a and 38a, respectively, with multiple templates so as to determine whether the candidate matches any of the patterns of the multiple templates. The templates are the image of an object of detection such as a man and the images of those other than the object of detection, such as a dog and a cat.

The pattern matching part 36b prepares the templates in, for instance, a few patterns, while the pattern matching part 38b prepares the templates in, for instance, tens of patterns. Accordingly, the first image sensing part 36 performs high-speed, real-time processing, while the second image sensing part 38 performs low-speed, high-accuracy processing.

When the first image sensing part 36 performs real-time processing on the video and no sensing result is determined, the high-accuracy processing request determination part 40 notifies the center apparatus 16 of a failure (of the sensing or real-time processing in the first image sensing part 36) from a real-time processing failure notification part 45 via the network 12. Further, using a random number, the high-accuracy processing request determination part 40 randomly selects one to request to perform substitutional processing from those of the image sensors 10₁ through 10ₙ currently having a low frequency of occurrence of sensing events and stored as advertisement information in the advertisement reception part 42. Then, the high-accuracy processing request determination part 40 causes the high-accuracy processing request transmission part 44 to transmit the video together with a request to perform substitutional low-speed, high-accuracy processing to the selected one of the image sensors 10₁ through 10ₙ via the network 12.

In the case where the center apparatus 16 includes a high-accuracy processing request reception part and an image sensing part for high-accuracy processing, the video and the request to perform substitutional low-speed, high-accuracy processing may be transmitted to the center apparatus 16.

Detection information as a sensing result obtained in the first image sensing part 36 is provided from the high-accuracy processing request determination part 40 to the detection result transmission part 46, and is transmitted therefrom to the center apparatus 16 via the network 12. Detection information obtained in the second image sensing part 38 is transmitted from the detection result transmission part 46 to the center apparatus 16 via the network 12.

The high-accuracy processing request reception part 48 receives video together with a request to perform substitutional high-accuracy processing transmitted to the image sensor 10₁ from the network 12, and stores the video in a substitutional processing image buffer 49. Based on the request, the second image sensing part 38 performs high-accuracy processing on the video read out from the substitutional processing image buffer 49.

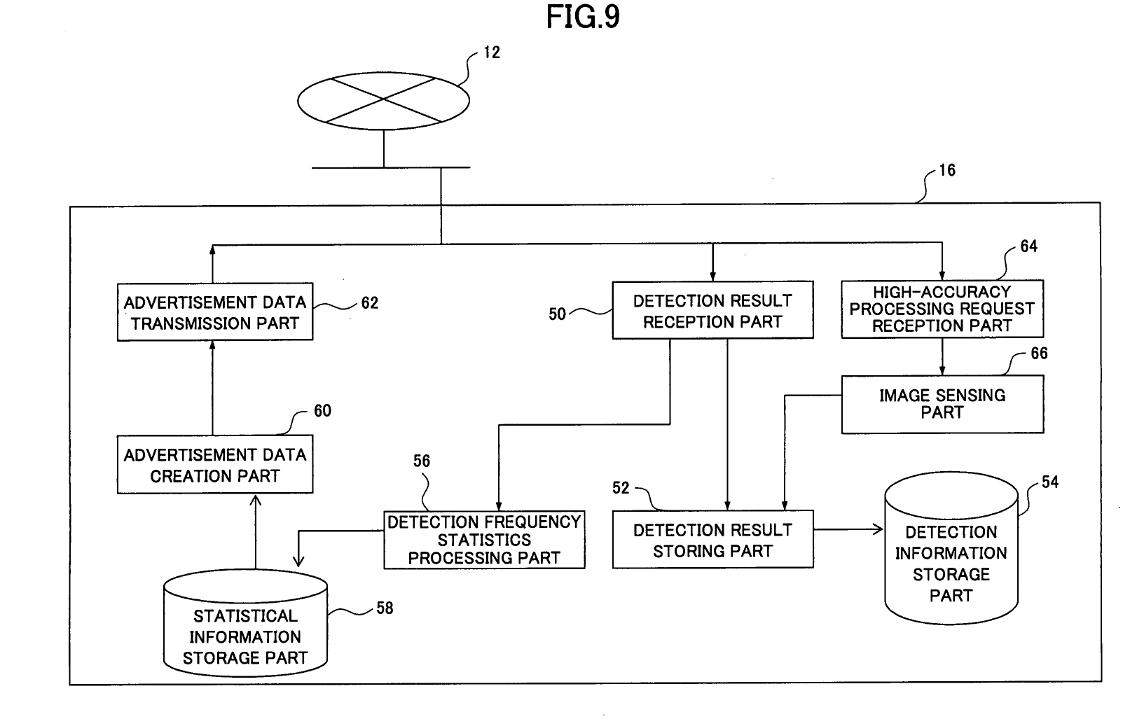

FIG. 9 is a functional block diagram showing a second embodiment of the center apparatus 16 of the present invention. In FIG. 9, the same elements as those of FIG. 6 are referred to by the same numerals. In the center apparatus 16 of FIG. 9, detection information transmitted from the image sensors 10₁ through 10ₙ to the center apparatus 16 via the network 12 is received by the detection result reception part 50, and is provided to the detection result storing part 52. The detection result storing part 52 stores the received detection information in the detection information storage part 54, sorting the received detection information based on its transmitters (the image sensors 10₁ through 10ₙ).

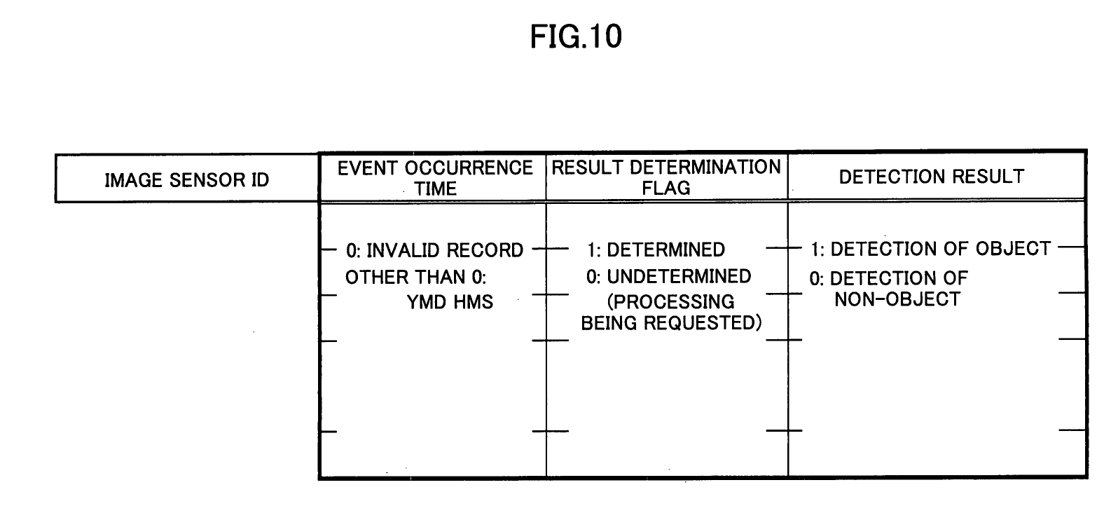

FIG. 10 is a diagram showing a detection information storage format in the detection information storage part 54. Referring to FIG. 10, an event occurrence time, a result determination flag showing whether processing is being requested, and a detection result such as whether an object has been detected are stored with respect to each of the image sensors 10₁ through 10ₙ.

The detection information received by the detection result reception part 50 is provided to the detection frequency statistics processing part 56. The detection frequency statistics processing part 56 takes statistics on the frequency of notification of sensing events with respect to each of the image sensors 10₁ through 10ₙ, and stores the obtained statistical information in the statistical information storage part 58.

With respect to each of the image sensors 10₁ through 10ₙ, the advertisement data creation part 60 specifies a period of time (a day of the week and time) when the frequency of occurrence of sensing events is lower than a predetermined threshold from the statistical information of the statistical information storage part 58. Then, the advertisement data creation part 60 periodically selects one or more of the image sensors 10₁ through 10ₙ in which the frequency of occurrence of sensing events is currently lower than the predetermined threshold and therefore, the work load on the CPU is small, and creates advertisement data that reports the addresses of the selected one or more of the image sensors 10₁ through 10ₙ and their periods of validity. The advertisement data is periodically transmitted from the advertisement data transmission part 62 to the network 12 and reported to all of the image sensors 10₁ through 10ₙ.

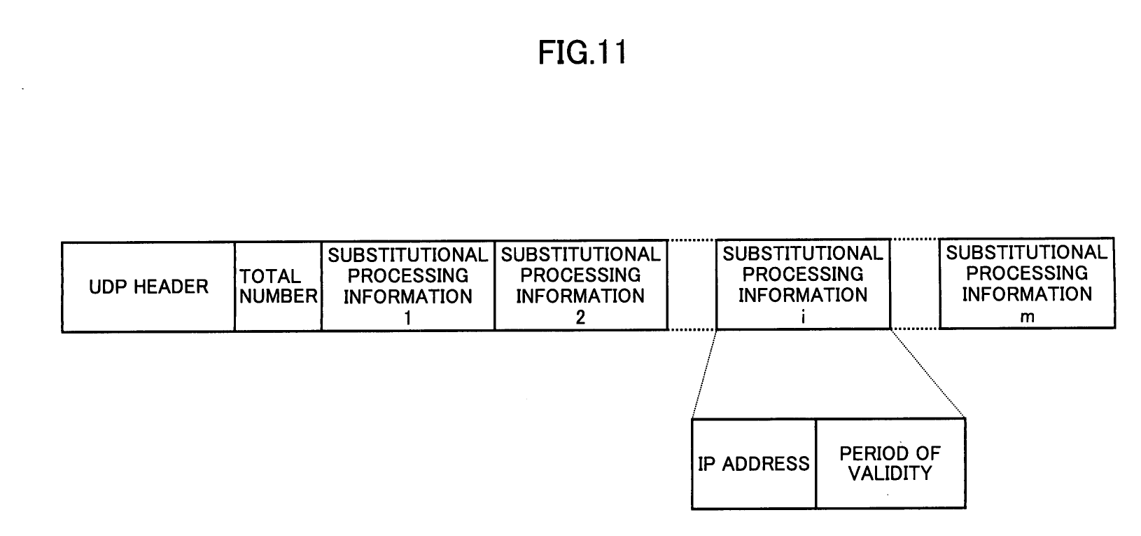

FIG. 11 is a diagram showing a format of the advertisement data transmitted by the center apparatus 16. A leading UDP (User Datagram Protocol) header part includes a reachable multicast address and a destination port number that is not used by another application in the system. Subsequently to this, the total number of substitutional processing information items and the substitutional processing information items are written. Each substitutional processing information item is composed of the IP address of a corresponding one of the image sensors 10₁ through 10ₙ and a period of validity. The period of validity is determined from the statistical information of the statistical information storage part 58, and is set to a value less than or equal to the transmission period of the advertisement data.

A high-accuracy processing request reception part 64 receives video together with a request to perform substitutional high-accuracy processing transmitted to the center apparatus 16 from the network 12. The high-accuracy processing request reception part 64 provides the video to an image sensing part 66 so that the image sensing part 66 performs high-accuracy processing on the video. Detection information obtained in the image sensing part 66 is provided to the detection result storing part 52, and is stored in the detection information storage part 54, the detection information being correlated with a corresponding one of the image sensors 10₁ through 10ₙ which one is a requestor of the high-accuracy processing.

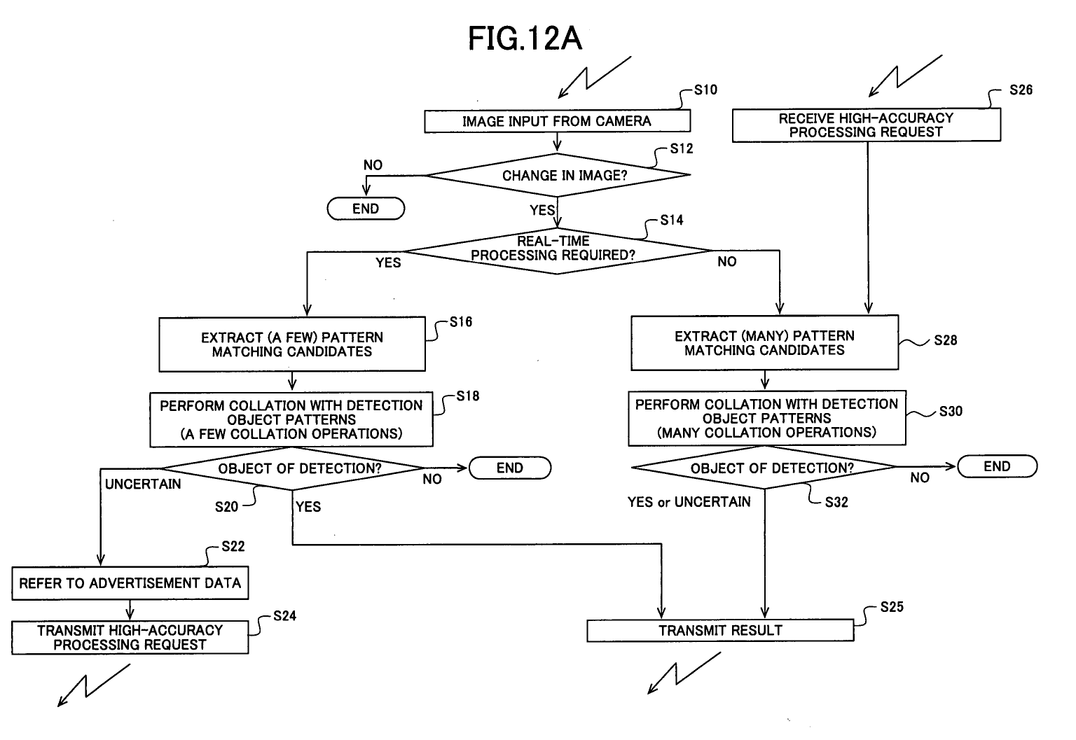

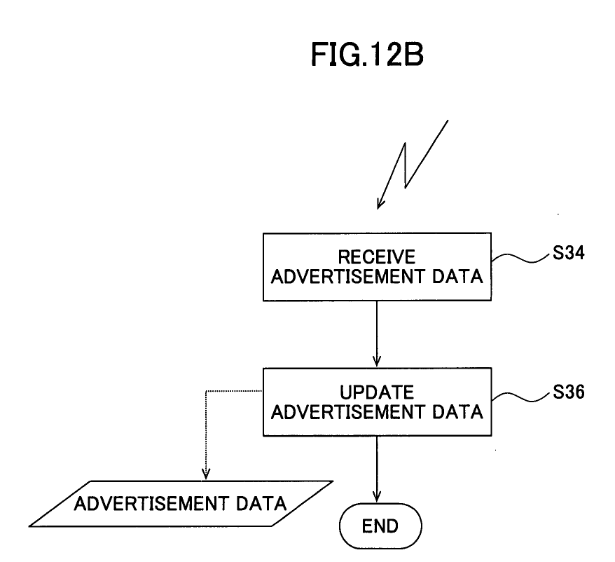

FIGS. 12A and 12B are flowcharts of processing performed by the image sensor 10ₙ of the present invention. In step S10 of FIG. 12A, video is input from the camera 30. Then, in step S12, the detection trigger detection part 32 determines whether there is a change in the video. If there is a change in the video, in step S14, the detection switch part 34 determines whether the frequency of occurrence of sensing events is higher than or equal to a predetermined value and high-speed, real-time processing is required.

If the real-time processing is required, in step S16, the pattern matching candidate extraction part 36a extracts (a small number of) parts including a movement from the video read out from the image buffer 33 as pattern matching candidates. Then, in step S18, the pattern matching part 36b performs pattern matching between each candidate and a small number of templates. That is, the pattern matching part 36b collates each candidate with a small number of templates to determine whether the candidate matches any of the patterns of the templates.

Thereafter, in step S20, it is determined whether the result of the sensing by the real-time processing is determined. If in step S20, the result of the sensing by the real-time processing is not determined, that is, it is uncertain whether it is an object of detection, in step S22, the high-accuracy processing request determination part 40 selects another image sensor to request to perform substitutional processing referring to advertisement information. Then, in step S24, the high-accuracy processing request determination part 40 transmits the video and a request to perform substitutional low-speed, high-accuracy processing to the selected image sensor. If the result of the sensing by the real-time processing is determined and an object of detection is detected in step S20, in step S25, the detection result transmission part 46 transmits detection information to the center apparatus 16.

On the other hand, if it is determined in step S14 that the high-speed, real-time processing is not required, or if in step S26, the high-accuracy processing request reception part 48 receives video together with a request to perform substitutional high-accuracy processing transmitted to the image sensor 10ₙ from the network 12, in step S28, the pattern matching candidate extraction part 38a extracts (a large number of) parts including a movement from the video read out from the image buffer 33 or the substitutional processing image buffer 49 as pattern matching candidates. Then, in step S30, the pattern matching part 38b performs pattern matching between each candidate and a large number of templates. That is, the pattern matching part 38b collates each candidate with a large number of templates to determine whether the candidate matches any of the patterns of the templates. Then, in step S32, it is determined whether it is an object of detection. If the result of the sensing by the high-accuracy processing is determined and an object of detection is detected, or if the result of the sensing is not determined in the determination of step S32, in step S25, the detection result transmission part 46 transmits detection information or the sensing result to the center apparatus 16.

Referring to FIG. 12B, in step S34, the advertisement reception part 42 receives advertisement data from the network 12. Then, in step S36, the advertisement reception part 42 updates stored advertisement information to the received advertisement data.

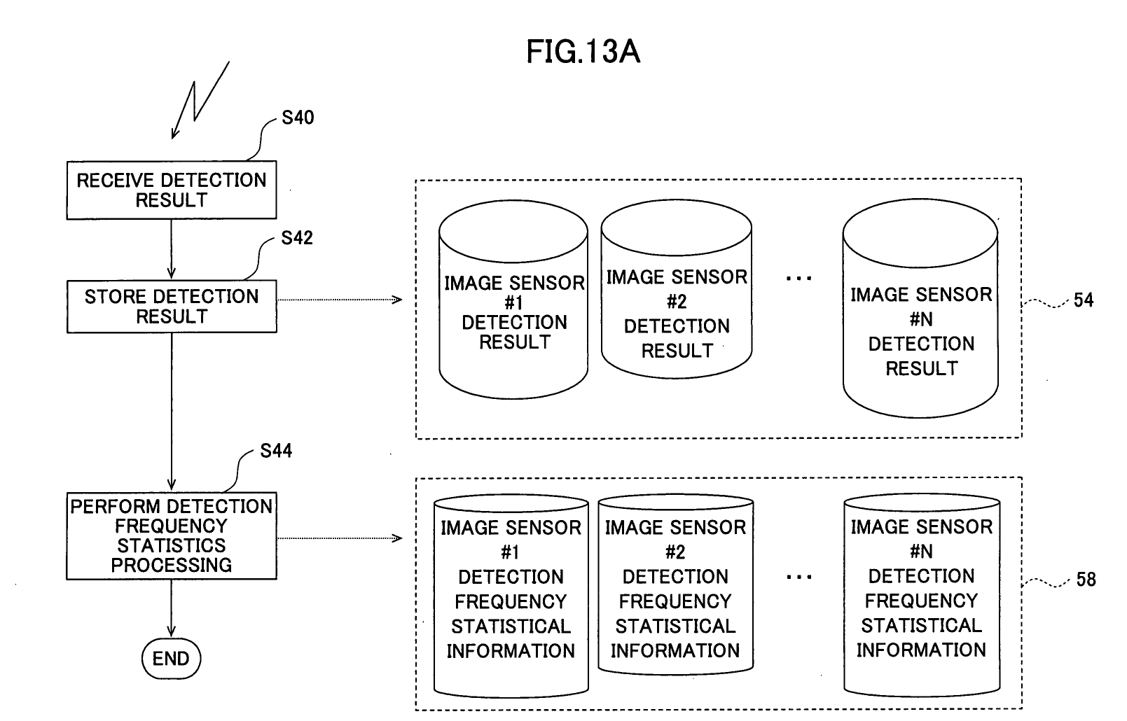

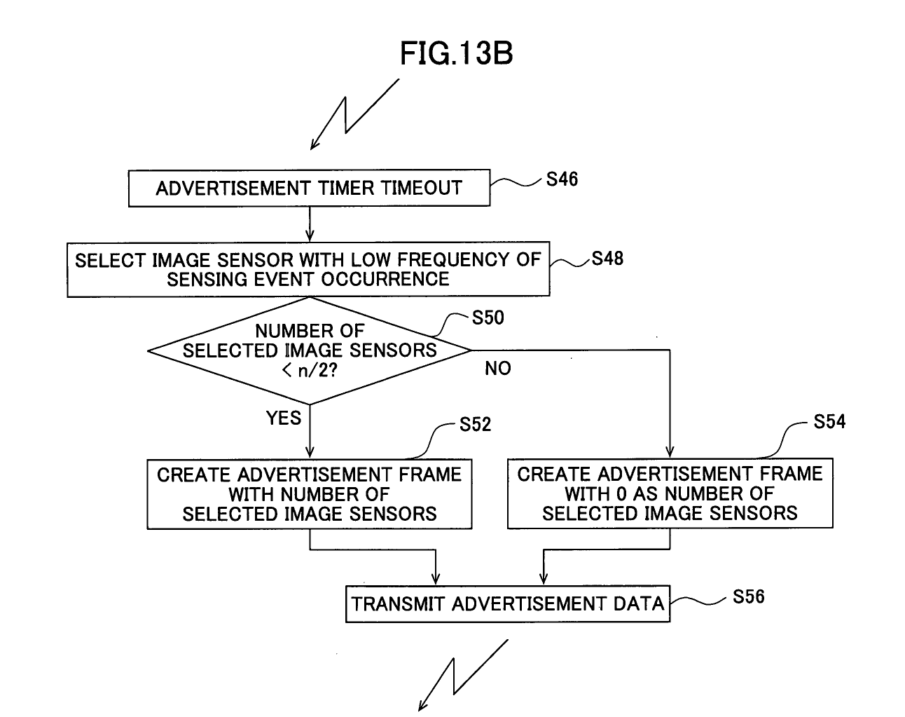

FIGS. 13A and 13B are flowcharts of processing performed by the center apparatus 16 of the present invention. In step S40 of FIG. 13A, the detection result reception part 50 receives detection information from the image sensors 10₁ through 10ₙ. In step S42, the detection result storing part 52 stores the received detection information in the detection information storage part 54, sorting the detection information based on its transmitters (the image sensors 10₁ through 10ₙ). Then, in step S44, the detection frequency statistics processing part 56 takes statistics on the frequency of notification of sensing events with respect to each of the image sensors 10₁ through 10ₙ, and stores the obtained statistical information in the statistical information storage part 58.

Referring to FIG. 13B, when an advertisement timer runs out (or an advertisement timer timeout occurs), in step S48, with respect to each of the image sensors 10₁ through 10ₙ, the advertisement data creation part 60 specifies a period of time (a day of the week and time) when the frequency of occurrence of sensing events is lower than a predetermined threshold from the statistical information of the statistical information storage part 58. Then, the advertisement data creation part 60 periodically selects one or more of the image sensors 10₁ through 10ₙ in which the frequency of occurrence of sensing events is currently lower than the predetermined threshold and therefore, the work load on the CPU is small.

Next, in step S50, the advertisement data creation part 60 determines whether the number of selected image sensors is less than a predetermined value X. The predetermined value X in the case where the total number of image sensors is n is set to, for instance, n/2. If the number of selected image sensors is less than the predetermined value X, in step S52, the advertisement data creation part 60 creates advertisement data in which the IP addresses of the selected image sensors are written in substitutional processing information. If the number of selected image sensors is more than or equal to the predetermined value X, in step S54, the advertisement data creation part 60 creates advertisement data in which zero is written as the total number of substitutional processing information items (that is, the IP addresses of the selected image sensors are not written in the substitutional processing information). Thereafter, in step S56, the created advertisement data is transmitted to the network 12 from the advertisement data transmission part 62.

If requests to perform substitutional processing from many image sensors concentrate on a small number of image sensors, processing congestion occurs in the image sensors requested to perform substitutional processing. Accordingly, in order to avoid this, when the number of image sensors selected by the advertisement data creation part 60 is more than or equal to the predetermined value X, the IP addresses of the selected image sensors are not written in the substitutional processing information.

In the image sensors 10₁ through 10ₙ, the advertisement reception part 42 may form an advertisement data retention part, the first image sensing part 36 may form a real-time processing part, the second image sensing part 38 may form a high-accuracy processing part, the high-accuracy processing request transmission part 44 may form a request part, and the detection switch part 34 may form a switch part. In the center apparatus 16, the detection result storing part 52, the detection frequency statistics processing part 56, the advertisement data creation part 60, and the advertisement data transmission part 62 may form a reporting part.

The video analysis system of the present invention is applicable to, for instance, a traffic monitoring system and a parking lot monitoring system that detect vehicles as sensing events by analyzing video.

The present invention is not limited to the specifically disclosed embodiments, and variations and modifications may be made without departing from the scope of the present invention.

The present application is based on Japanese Priority Patent Application No. 2004-080771, filed on Mar. 19, 2004, the entire contents of which are hereby incorporated by reference.

1. A video analysis system detecting a sensing event by analyzing video captured in each of a plurality of image sensors connected to a network, and notifying a center apparatus of detection information via the network to manage the detection information, wherein:
the center apparatus determines at least one of the image sensors in which one a frequency of occurrence of the sensing event is statistically low by recording a frequency of the notification from each of the image sensors, and reports the determined at least one of the image sensors to the image sensors as advertisement data; and
each of the image sensors, when being unable to detect the sensing event by real-time processing that is a high-speed video analysis, selects a specific one of the image sensors based on the received advertisement data, and requests the specific one of the image sensors to perform high-accuracy processing that is a low-speed, high-accuracy video analysis.

2. The video analysis system as claimed in claim 1, wherein each of the image sensors, when being unable to detect the sensing event by the real-time processing, selects one of the specific one of the image sensors and the center apparatus based on the received advertisement data, and requests the selected one of the specific one of the image sensors and the center apparatus to perform the high-accuracy processing.

3. An image sensor in a video analysis system detecting a sensing event by analyzing video captured in each of a plurality of image sensors connected to a network, and notifying a center apparatus of detection information via the network to manage the detection information, the image sensor comprising:
an advertisement data retention part configured to receive and retain advertisement data of at least one of the image sensors in which one a frequency of occurrence of the sensing event is low, the advertisement data being reported from the center apparatus;
a real-time processing part configured to perform high-speed video analysis;
a high-accuracy processing part configured to perform low-speed, high-accuracy video analysis; and
a request part configured to select a specific one of the image sensors based on the received advertisement data and request the specific one of the image sensors to perform high-accuracy processing that is the low-speed, high-accuracy video analysis when the sensing event is undetectable by the real-time processing part.

4. The image sensor as claimed in claim 3, wherein the request part selects one of the specific one of the image sensors and the center apparatus based on the received advertisement data and requests the selected one of the specific one of the image sensors and the center apparatus to perform the high-accuracy processing when the sensing event is undetectable by the real-time processing part.

5. The image sensor as claimed in claim 3, further comprising:
a switch part configured to cause the real-time processing part to operate when the frequency of occurrence of the sensing event in the image sensor is higher than or equal to a predetermined value, and cause the high-accuracy processing part to operate when the frequency of occurrence of the sensing event in the image sensor is lower than the predetermined value.

6. The image sensor as claimed in claim 5, wherein:
the real-time processing part performs pattern matching between a small number of candidates extracted from the video with a small number of templates; and
the high-accuracy processing part performs pattern matching between a large number of candidates extracted from the video with a large number of templates.

7. A center apparatus in a video analysis system detecting a sensing event by analyzing video captured in each of a plurality of image sensors connected to a network, and notifying the center apparatus of detection information via the network to manage the detection information, the center apparatus comprising:
a reporting part configured to determine at least one of the image sensors in which one a frequency of occurrence of the sensing event is statistically low by recording a frequency of the notification from each of the image sensors, and report the determined at least one of the image sensors to the image sensors as advertisement data.

8. The center apparatus as claimed in claim 7, further comprising:
a high-accuracy processing part configured to perform low-speed, high-accuracy video analysis.
